(19) United States
(12) Patent Application Publication
(10) Pub. No.: US 2005/0287993 A1
(43) Pub. Date: Dec. 29, 2005

(54) Apparatus, system, and method for providing voicemail service using a packet data messaging system

(76) Inventor: Aleksandar Gogic, San Diego, CA (US)

Correspondence Address: QUALCOMM, INC, 5775 MOREHOUSE DR., SAN DIEGO, CA, 92121, US

(21) Appl. No.: 11/133,655

(22) Filed: May 19, 2005

Related U.S. Application Data
(60) Provisional application No. 60/574,757, filed on May 26, 2004.

(51) Int. Cl. H04M 1/64; H04M 11/00

(52) U.S. Cl. 455/413; 379/88.13

(57) ABSTRACT

An apparatus, system, and method provide voicemail service using a packet data messaging service such as multimedia message service (MMS). Upon detecting that the call has been diverted to the voicemail server, rather than using a real-time voice connection to record a voicemail message, the voicemail message is recorded at an origination mobile station and transmitted in a packet data message through a packet data messaging service center such as a multimedia messaging service center (MMS-C). If the destination device is a destination mobile station subscribing to the packet data messaging service, the packet data message is deposited in the destination mobile station. Where the destination device is a device without access to the service, the packet data message is forwarded to a destination address in a voice mail server associated with the voicemail box of the destination device.

### CLAIM OF PRIORITY UNDER 35 U.S.C §119

The present Application for Patent claims priority to U.S Provisional Application No. 60/574,757, entitled “Interworking Between Wireless Voicemail and MMS to Achieve Efficient Use of Network Resources”, filed May 26, 2004, and assigned to the assignee hereof and hereby expressly incorporated by reference herein

### RELATED APPLICATION

The present application is also related to U.S. utility application entitled “Apparatus, System, And Method for Providing Voicemail Service Using Presence Status in Packet Data Messaging System”, having attorney docket number 040573U2 and filed concurrently herewith this application.

### BACKGROUND

I. Field

The invention relates in general to voicemail systems and more specifically to an apparatus, system, and method for providing voicemail service through a packet data messaging system.

II. Background

Voicemail systems provide a mechanism for an origination party to record a voice message that can be retrieved by a destination party. Typically, a voicemail box associated with a telephone number of the destination party is used to store the conventional voicemail systems, a real-time call such as a circuit switched call or a virtual circuit switched call is maintained with the voicemail server while voicemail message is deposited or retrieved. In circumstances where communication resources are limited, however, conventional systems have substantial drawbacks. In conventional wireless communication systems, for example, bandwidth and communication channels are valuable resources that are often used for retrieving and depositing voicemail messages. Since only one party is involved with the transfer of a voicemail message at any particular time, a low latency, real-time communication link is not required. Using a circuit switched call in a circuit switched network, or a virtual circuit switched call in a packet switched network, to deliver or retrieve voicemail messages results in an inefficient use of wireless resources. In systems utilizing packet switched networks such as VoIP (Voice over Internet Protocol) networks, for example, establishing a real-time call for a voicemail submission or retrieval results in an inefficient use of resources since a voice quality call is established for the virtual circuit switched connection. Data packets exchanged during the voicemail call are unnecessarily treated as high priority, low latency data packets required for a real-time call.

Accordingly, there is a need for an apparatus, system, and method for efficiently providing voicemail services in a wireless communication system.

### BRIEF DESCRIPTION OF THE DRAWINGS

FIG. 1 is a block diagram of a communication system in accordance with an exemplary embodiment of the invention.

FIG. 2 is a block diagram of the exemplary communication system where a first mobile station is an originating device and a second mobile station is a destination device.

FIG. 3 is a block diagram of the communication system in accordance with the exemplary embodiment where the destination device does not receive packet data messaging services.

FIG. 4 is a block diagram of the origination mobile station in accordance with the exemplary embodiment of the invention.

FIG. 5 is a flow chart of a method of providing voicemail service using packet data messaging service in accordance with the exemplary embodiment of the invention.

FIG. 6 is a flow chart of a method of providing voicemail service using packet data messaging service performed in a voicemail server.

### DETAILED DESCRIPTION OF THE PREFERRED EMBODIMENTS

An apparatus, system, and method efficiently provide voicemail services in a wireless communication system. Voicemail messages are deposited and retrieved using a packet data messaging system such as a multimedia message service (MMS) system.

Resources are efficiently managed by minimizing the durations of real-time calls in the wireless communication system. Voicemail messages are exchanged using higher latency packet data transmissions than required for voice quality calls. Voicemail messages deposited by a wireless user are recorded at an origination mobile station and transmitted through a packet data communication link as a packet data message. Voicemail messages retrieved by a wireless user are received at a destination mobile station through a packet data communication link and stored in memory at the mobile station. Voicemail clients that do not subscribe to the packet data message service, or otherwise do not use the packet data service, can retrieve voicemail messages using conventional techniques since the voicemail message are retained by the voicemail server. Employing a packet data messaging system maximizes the efficiency of the use of wireless communication resources for voicemail services. Since a greater degree of latency can be tolerated with the transmission of a packet data message, for example, the packet data message that includes a voicemail message can be efficiently transferred at a lower QoS (quality of service) level than required by circuit switched calls in circuit switched networks or virtual circuit switched calls in packet switched networks. Communication resources are, therefore, efficiently assigned using a QoS policy that may result in increased latency while employing channels having a higher data transfer rate than a circuit switched or virtual circuit switched call.

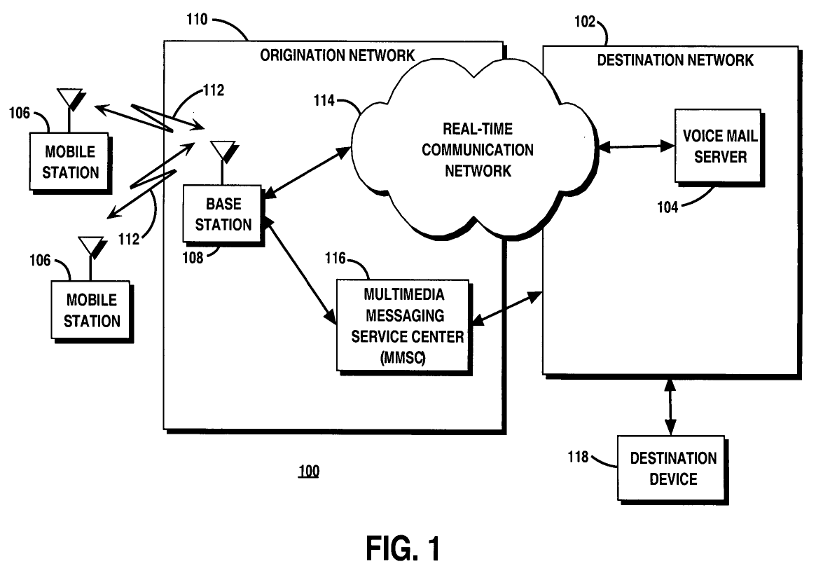

FIG. 1 is a block diagram of a communication system 100 in accordance with an exemplary embodiment of the invention where the destination network 102 includes a voicemail server 104. Origination mobile stations 106 communicate with a base station 108 of an origination network 110 through wireless communication channels 112. At least a portion of the origination network 110 includes a wireless communication system which may be any cellular, radio, optical, or other wireless system that facilitates the wireless exchange of signals with at least one mobile unit 106. Examples of suitable wireless communication systems include cellular telephone systems operating in accordance with Code Division Multiple Access (CDMA) or Global System for Mobile Communication (GSM) standards. The wireless communication system of the origination network 110 has one or more base stations 108 that exchange wireless signals with the mobile stations 106 to establish communication with the mobile stations 106. The base stations 108 are connected to a real-time communication network 114 that routes mobile station calls in accordance with known techniques. The real-time communication network 114 includes any combination of routing and/or switching equipment, communication links, and other infrastructure suitable for establishing a real-time communication link between the base station 108 and a voicemail server 104 in the destination network 102. Where the real-time communication network 114 is a circuit switched network, the real-time communication network 114 comprises a mobile switching center (MSC), switches, and transmission equipment among other hardware and software that facilitates establishing a dedicated communication link between the base station 108 and the voice mail server 104. In the exemplary embodiment, however, the real-time communication network 114 is a packet switched network comprising one or more Internet Protocol (IP) routers that facilitate the exchange of data packets using Internet Protocol (IP) to establish a virtual circuit switched communication link between the base station 108 and the voicemail server 104. In accordance with known techniques, a real-time call can be established between a mobile station 106 and another device, such as the voicemail server 104, by prioritizing and managing the transmission of data packets. The real-time communication network 114 includes equipment for interfacing and managing communications with the mobile station 106 through the base station 108. For example, the real-time communication network 114 may include a mobile switching center emulator (eMSC) in some situations. The cloud representing the real-time communication network 114 in the FIG.s is shown overlapping the origination network 110 and the destination network 102 to illustrate that components within the origination network 110 and the destination network 102 can be considered as part of the real-time communication network 114. Further, some of the equipment and infrastructure used to establish communication through the real-time communication network 114 may be utilized by the packet data messaging system discussed immediately below.

A packet data messaging system transmits data packets through the packet switched network to exchange messages containing the voice mail messages. The packet data messaging system may be any type of packet data system that provides a mechanism for routing data packets that contain files or other information representing the contents of voicemail messages. An example of a suitable packet data messaging system includes an electronic mail (email) system that is capable of routing email messages having attached audio files. In the exemplary embodiment, the packet data messaging system is a multimedia messaging service (MMS) system that facilitates the exchange of text, video, audio and graphics files between appropriately equipped mobile stations 106 and other devices serviced by the MMS system. The other devices may be serviced by the same wireless network, a different wireless network, a wired network, or a computer network. A packet data messaging service center stores and manages the packet data messages exchanged with the mobile stations 106. In the exemplary embodiment the packet data message service center is a multimedia messaging service center (MMS-C) 116 that stores and manages multimedia messages exchanged with the mobile stations 106. The MMS-C 116 includes a MMS server and a MMS relay (not shown in FIG. 1). In some circumstances, other equipment, servers, networks, and storage may be connected to the MMS-C 116. For example, temporary message storage devices and permanent message storage devices may be used to store MMS messages. Those skilled in the art will readily recognize the various topologies, protocols, architectures, and implementations of the communication system 100, origination network 110 and destination network 102 that can be used based on these teachings as applied to known techniques. The functions and operations of the blocks described in FIG. 1 may be implemented in any number of devices, circuits, or infrastructure. Two or more of the functional blocks may be integrated in a single device and the functions described as performed in any single device may be implemented over several devices. For example, the communication link between the base station 108 and the MMS-C 116 includes other distinct origination network 110 elements not shown in FIG. 1 such as a base station controller (BSC) and a packet data access gateway switching node (PDSN).

In the exemplary embodiment, the communication system 100 utilizes Voice over Internet Protocol (VoIP) techniques over packet switched networks. A Session Initiation Protocol (SIP) facilitates the establishment of virtual circuit switched calls between calling parties and called parties such as between an origination mobile station 106 and a destination device 118. In some circumstances, the communication system 100 may include one or more circuit switched networks such as Public Switched Telephone Network (PSTN).

The voicemail server 104 stores, generates, and plays greetings and voicemail messages to provide voicemail services to voicemail clients. The voicemail server 104 communicates with switching or routing equipment in the real-time communication network 114 and, in some circumstances, with the MMS-C 116 and may be connected within the same network (110) with the switching or routing equipment and the MMS-C 116 or may be connected within another communication network (102).

Depending on the particular situation, a wireless communication system may comprise a voicemail origination network 110, a voicemail destination network 102, or both. Therefore, a mobile station 106 may be used to deposit a voicemail for another party or may be used to retrieve a voicemail deposited by the other party where the other party's communication device may be a mobile station 106 on the same wireless network, a mobile station 106 on a different wireless network, or a landline device connected to a landline communication network such as a PSTN. In the exemplary system shown in FIG. 1, the other party's device (destination device 118) is illustrated as connected to the origination network 110 through the destination network 102. In some situations, however, the destination network 102 and the origination network 110 may be the same network. The communication networks 102, 110 may include any number of wireless, wired, computer, Internet, or Intranet networks.

In accordance with the exemplary embodiment of the invention, the mobile stations 106 exchange MMS messages including voicemail messages with the MMS-C 116. Where the mobile station is the originating device, the origination party (calling party) records a voicemail message for a destination party (called party) at the origination mobile station. The voicemail message is stored, at least temporarily, in memory of the origination mobile station and is forwarded through the MMS-C 116 to the destination network 102. If the destination device is landline telephone, or other device without MMS service, the MMS message is stored in the voicemail server 104 for the destination device 118. Where the destination device 118 is a properly equipped mobile station which supports MMS (destination mobile station), the voicemail message can be deposited in the destination mobile station without storing the voicemail message in the voicemail server 104. In the exemplary embodiment, however, the voicemail message is sent to the voicemail server 104 for retrieval of the voicemail by a destination device 118 by conventional techniques when the destination device is not MMS capable or has not been configured to receive MMS. The voicemail message deposited for the user of the destination mobile station (118) is transferred to the destination mobile station (118) from the MMS-C 116 as an MMS message. The MMS message is stored in the memory of the destination mobile station (118) and locally played when the user accesses the voicemail. In some situations, the voicemail message may be streamed to the destination mobile station (118) allowing playback of the voicemail message before the entire message file is transferred. Therefore, a packet data message, such as a MMS message, including the recorded voicemail message is transmitted through a packet data communication link, such as a MMS communication link, to the destination network 102.

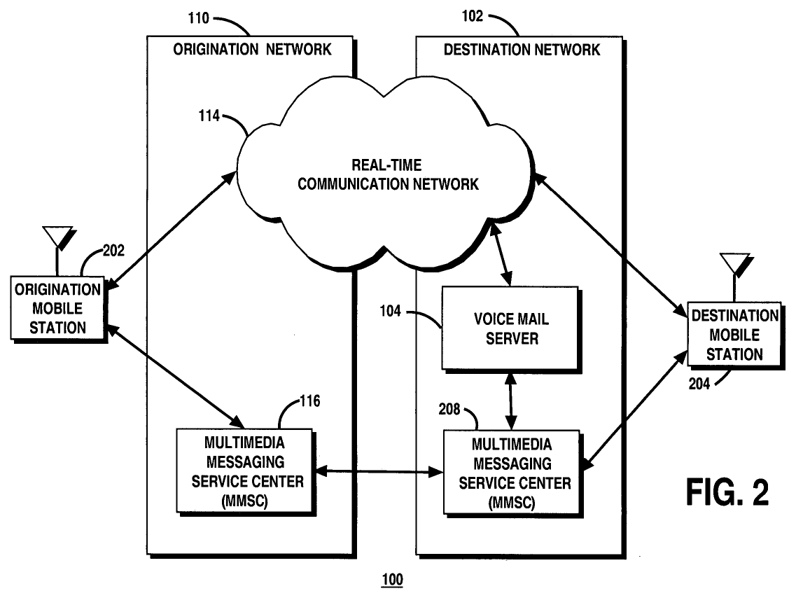

FIG. 2 is a block diagram of the exemplary communication system 100 where a first mobile station 106 is an originating device (originating mobile station 202) and a second mobile station 106 is a destination device (destination mobile station 204). In the exemplary situation discussed with reference to FIG. 2, the originating mobile station 202 communicates through the origination network 110 and the destination mobile station 204 communicates through a destination network 102 where the origination network 110 and the destination network 102 each comprise a MMS-C 116, 208 as well as IP routers that at least partially comprise the real-time communication network 114. As explained above, the real-time communication network 114 comprises switching equipment including mobile switching centers (MSCs) where the real-time communication network 114 is a circuit switched network. In the interest of clarity, the base station 102 and other communication equipment are not shown in FIG. 2. The voicemail server 104 in the destination network 104 provides voicemail services for destination devices 118 such as the destination mobile station 204. Those skilled in the art will readily recognize the various topologies, protocols, architectures, and implementations of the communication network 100 that can be used based on these teachings and known techniques. The functions and operations of the blocks described in FIG. 2 may be implemented in any number of devices, circuits, or infrastructure. Two or more of the functional blocks may be integrated in a single device and the functions described as performed in any single device may be implemented over several devices. For example, the functionality of the voicemail server 104 may be implemented within the MMS-C 208.

A voicemail delivery procedure is invoked when the originating mobile station 202 attempts to place a call to the destination mobile station 204 and the call can not be completed. In accordance with known techniques, the origination mobile station 202 places a call through equipment in the origination network of the real-time communication network 114 to communication equipment of the destination network 204. The real-time communication network 114 detects that the destination mobile station 204 is busy, out of range, not replying or otherwise unavailable to accept the call. In the exemplary embodiment, the VoIP equipment detects that the destination mobile station 204 is unavailable by determining that a page was not answered or by determining that a call forwarding feature has been activated to forward calls to voicemail. In response, the call is redirected to the voicemail server 104. In the exemplary packet switched situation discussed with reference to FIG. 2, the voicemail server 104 forwards a voicemail acknowledgement message to the origination mobile station 202 using (Session Initiation Protocol (SIP) used for VoIP signaling. In circuit switched networks, a MSC detects the unavailability of the destination device, forwards the call to the voicemail server 104 and a circuit switched call is temporarily completed with the origination mobile station 202. The voicemail acknowledgment message is forwarded to the origination mobile station 202 indicating that the voicemail server 104 has accepted the call.

The origination mobile station 202 replies to the voicemail acknowledgement message by sending a MMS-invoked message indicating that the MMS system will be employed to submit the voicemail message. As explained above, VoIP and SIP are used in the exemplary embodiment. The voicemail acknowledgment message and the MMS-invoked message are forwarded through the communication system 100 using SIP extensions. In the exemplary embodiment, therefore, the MMS-invoked message is conveyed using an SIP extension and indicates that a VoIP media connection will not be established. In embodiments utilizing circuit switched networks, the MMS-invoked message may include a tone sequence or other in-band, as well as out-of-band, signaling technique available in circuit switched systems. After sending the MMS-invoked message, the origination mobile station 202 terminates the real-time call and continues with submitting the voicemail message using the MMS. If the origination mobile station 202 does not send a MMS-invoked message, the voicemail delivery procedure continues in accordance with known techniques allowing the originating party to record a message at the voicemail server 104 for the destination party.

In some circumstances, a greeting message associated with the destination mobile station 204 is stored in the voicemail server 104. In the exemplary embodiment, the greeting message is submitted by the voicemail server through the MMS system in a MMS message to the destination mobile station 202. The voicemail server 104 generates a MMS message using the addressing information of the origination mobile station 202 and a file including the greeting message. Although the greeting message file may have any of several formats, the greeting message file is formatted in accordance with the vocoder used by the origination mobile station 202 in the exemplary embodiment. An example of a suitable vocoder format in a CDMA system includes the Enhanced Variable Rate Coder (EVRC). The MMS message including the greeting file is routed through the MMS system and is deposited and played in the origination mobile station 202 to the calling party.

Where the communication system 100 includes a circuit switched network, other mechanisms may be used to present the greeting message to the calling party. One technique includes forwarding caller ID information from the voicemail server 104 to the MMS-C 208 to provide addressing information. The MMS greeting message is generated at the MMS-C 208 based on the origination address associated with the caller ID number. In some situations, the greeting message may be played by the voicemail server 104 through the virtual circuit switched call or circuit switched call prior to termination of the real-time call with the voicemail server 104.

The originating mobile station 202 records a voicemail message by capturing audio signals through a microphone and/or video signals through a camera and storing a digital representation of the signals in memory. Examples of suitable audio formats include WAV, EVRC, and AMR files. An example of a suitable format for storing video or multimedia files includes the MPEG4 format. Those skilled in the art will recognize the various other formats that can be used for storing and transmitting audio, video, and multimedia files.

After the appropriate processing of the voicemail message file, the origination mobile station 202 generates a MMS message addressed to the destination mobile station 204 using the destination mobile address. Examples of suitable destination addresses include an email address or any address routable using Internet Protocol (IP). Since in the exemplary embodiment the call is a VoIP call, addressing information for the destination mobile station 204 is established at the time of session initiation of the virtual circuit switched call (VoIP call). Accordingly, Internet routable addressing information is available at the origination mobile station 202 or through a network-resident proxy device such as a SIP signaling controller and any MMS messages from the originating mobile station 202 to the destination mobile station 204 can be routed using the destination address used for the original VoIP call. Where the call is a circuit switched call, however, the MMS message transmitted from the origination mobile station 202 must be associated with the destination mobile station 204. An example of a suitable method for establishing addressing information in a circuit switched system includes forwarding the destination address associated with the destination telephone number to the destination mobile station 202 through in-band or out-of-band signaling during the circuit switched call between the origination mobile station 202 and the voicemail server 104 using an address conversion database such as telephone number mapping (ENUM) or other suitable mechanism. In some situations, the destination address may be stored at the origination mobile station 202 and associated with the destination mobile station 204 telephone number. For example, an Internet routable destination address such as an email address may be stored in an address book of the origination mobile station 202.

The destination mobile station 202 generates a multimedia messaging service (MMS) message containing a file or other data representing the voicemail message. In the exemplary embodiment, the MMS message includes the voicemail message as an attached digital file and includes the destination address of the destination mobile station. The MMS message is forwarded to the MMS-C 116 and routed through the communication system to the MMS-C 208 of the destination network 102 in accordance with known MMS techniques. Generally, the MMS message is routed to a multimedia server in the MMS-C 208 based on the destination address and stored in memory at the MMS-C 208.

The MMS server in the MMS-C 208 deposits the voicemail message in the destination mobile station 204. In accordance with MMS techniques, for example, the MMS-C 208 stores the content of the MMS message and makes it available as a dynamically generated URL link to local data file. In the exemplary embodiment, a data file such as a WAV audio file representing the voicemail message is associated with the MMS message. Where the audio file cannot be deposited in the destination mobile station 204, a notification is transmitted to the destination mobile station 204 indicating that a message has arrived and is available for download. Depending on the particular configuration of the destination mobile station 204, the MMS message may be retrieved with or without user intervention. In some circumstances, the message may be streamed to the destination mobile station 204 allowing the voicemail message to be played before the entire file is transferred into the memory of the destination mobile station 204.

Although various protocols, signaling schemes, and formats can be used to deposit the MMS message in the destination mobile station 204, established MMS techniques are used in the exemplary embodiment. For example, the MMS-C 208 generates and transmits a MMS notification message to the destination mobile station 204 using a Wireless Application Protocol (WAP) “Push” procedure over Short Message Service (SMS). The MMS notification message contains a URL pointer to the dynamically generated MMS message including the audio file representing the voicemail message. After receiving the MMS notification message, the mobile station initiates a data connection that provides TCP/IP network connectivity. The destination mobile station 204 performs an HTTP (or WSP) “get” procedure to retrieve the MMS message from the MMS-C. In the exemplary embodiment, the MMS message is transmitted using any of several protocols utilized in the mobile communication systems. Examples of suitable protocols include M-IMAP, OMA-MM1, and SIP-based MM1. In addition, email protocols such as IMAP and POP can be used in some circumstances.

In the exemplary embodiment, an alert message is sent to the destination mobile station 204 after the voicemail message is received at the voicemail server 104. The alert message notifies the destination mobile station 204 that a voicemail message is available at the voicemail server 104. The alert message allows for notification and recovery of the voicemail message where an error has occurred with the MMS message. The alert message is transmitted to the destination mobile station 204 in accordance with known techniques and protocols. An example of a suitable method for alerting the destination mobile station 204 includes transmitting the alert message using Short Message Service (SMS) message.

The foregoing discussion focuses on voice mail submission by an originating device subscribing to the packet data messaging service such as MMS. In the exemplary embodiment, however, a destination mobile device 204 can be used to retrieve voicemail messages stored at the voicemail server 104. Such a situation may arise where the voicemail server 104 records a voice mail message left by an originating party using conventional techniques or where an MMS message could not be deposited in the destination device 204 and was alternatively routed for storage at the voicemail server 104. Another situation may arise where the originating party directly accesses the destination voicemail box through the voicemail system to leave a message for the voicemail subscriber associated with the voicemail box.

In the situation where the originating device is not a MMS compliant device and attempts to complete a call to the destination mobile station 204 and the destination mobile station 204 is busy, out of range or otherwise unavailable, the call is redirected to the voicemail server 104. After the originating device has established a call with the voicemail server 104, the voicemail server 104 may play a greeting and provides and indicator, such as a beep, that recording has commenced. The recorded message is stored in the voicemail server 104.

The voicemail message is forwarded to the MMS server using a suitable interface and protocol. In the exemplary embodiment, the voicemail message is transmitted as a file using the Simple Mail Transfer Protocol (SMTP). The SMTP includes a destination address field allowing the SMTP message to be routed to the appropriate MMS server and destination mobile station 204. In the exemplary embodiment, the voicemail server 104 includes an address correlation table that associates phone numbers with email addresses of mobile stations having MMS service. In some situations, a Domain Name Server (DNS) may be required to translate domain names into IP addresses. In accordance with known techniques, the message containing the voicemail message is routed through the communication system 100 to the MMS server providing service to the destination mobile station 204.

The MMS-C 208 deposits the voicemail message in the destination mobile station 204. The MMS-C 208 generates a MMS message to include a file or other data representing the voicemail message. The MMS message including header information and the attached voicemail file is stored in memory at the MMS server. In accordance with MMS techniques, the MMS-C 208 stores the content of the MMS message and makes it available as a dynamically generated URL link. In the exemplary embodiment, a data file such as a WAV audio file representing the voicemail message is associated with the MMS message. A notification is transmitted to the destination mobile station 204 indicating that a message has arrived and is available for download. In some circumstances, the deposit of the MMS message constitutes the new message notification. Depending on the particular configuration of the destination mobile station 204, the MMS message may be retrieved with or without user intervention. As discussed above, the message may be streamed to the destination mobile station 204 allowing the voicemail message to be played before the entire file is transferred into the memory of the destination mobile device 204.

Therefore, voicemail messages may be forwarded to destination mobile stations 204 either directly from an originating device (202) that has access to the packet data messaging service or from a voicemail server 104. In exemplary embodiment discussed above focusing on a MMS compliant originating device (202), a voicemail message is submitted using the MMS system by recording a message at an origination mobile station 202, generating a MMS message including the voicemail message as an attached file, and routing the message to the destination mobile station 204 based on the destination address of the destination mobile station 204. After the attempted call to the destination mobile station 204 is redirected to the voicemail server 104, the origination mobile station 202 receives a voicemail acknowledgement indicating that a voicemail server 104 has accepted the call. The call between the origination mobile station 202 and the voicemail server 104 is terminated and a voicemail message is recorded by the originating mobile station 204. A MMS message is generated including a voicemail message file and header information based on the destination address of the destination mobile station 204. As discussed in further detail below, an originating mobile station 202 may submit voicemail messages using the packet data messaging system in situations where the destination device is not able to receive the packet data messaging service. Accordingly, the advantages of utilizing a relatively high latency, high data rate packet data link alternatively to a real-time low latency circuit switched call or virtual circuit switched call can be realized when either the originating device, destination device, or both can exchange messages using a packet data messaging system such as MMS.

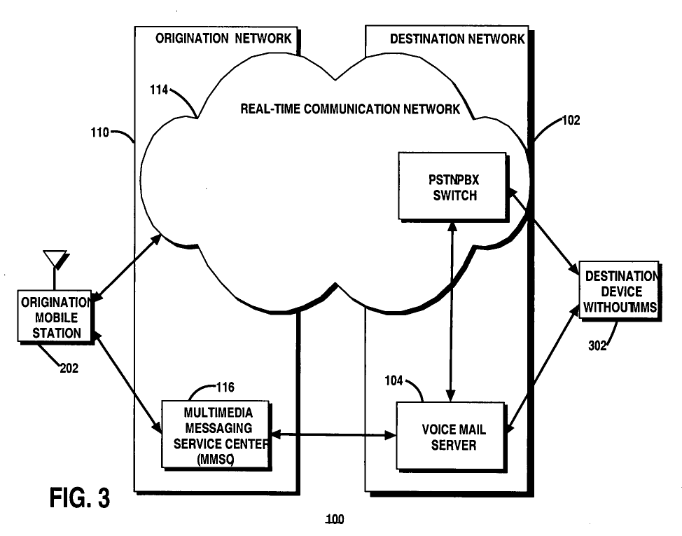

FIG. 3 is a block diagram of the communication system 100 in accordance with the exemplary embodiment where the destination device 302 does not receive MMS service. The destination device 302 is a landline telephone in the exemplary embodiment discussed with reference to FIG. 3 and is connected to the communication system 100 through a telephone switch 304 such as a PSTN switch or PBX (Private Branch eXchange) switch 304 that is part of the real-time communication network 114.

The telephone switch 304 redirects a call placed to the destination device 302 by the origination mobile station 202 to the voicemail server 104 when the telephone switch 304 detects that the destination device 302 is busy or otherwise unavailable. After accepting the call, the voicemail server 104 sends a voicemail acknowledgment signal to the origination mobile station 202 indicating the voicemail server 104 has accepted the call. In the exemplary embodiment, the voicemail server 104 sends a destination address corresponding to a voicemail box of the destination device 302 and SIP extensions provide a mechanism for transmitting the destination address and voicemail acknowledgement. As discussed above, the destination address and the acknowledgement may be sent using in-band or out-of-band signaling in a circuit switched system.

In the exemplary embodiment, the origination mobile station 202 terminates the session with the voicemail server 104 after the greeting is played to through the origination mobile station 202. In some circumstances, the origination mobile station 202 may terminate that call immediately after receiving the voicemail acknowledgment. In such circumstances, the voicemail server 104 forwards a MMS greeting message to the origination mobile station 202 which plays the greeting for the calling party.

The origination mobile station 202 records a voicemail message in accordance with the technique described above with reference to FIG. 2. Using the destination address, the origination mobile station 202 generates and forwards a MMS message including the voicemail message through the MMS system to the voicemail server 104. The message is routed through the MMS-C 116 to the destination address in the voicemail server 104. The voicemail server 104 stores the attached voicemail file in a location associated with the voicemail box of the destination device 302 and sends a voicemail notification to the destination device 302 which invokes a message waiting light, a distinctive dial tone, or other notification mechanism. The destination party retrieves the voicemail message by accessing the voicemail server 104 in accordance with known techniques. Depending on the format of the stored voicemail message, the voicemail server 104 may need to convert the voicemail message before playing the message for the destination party.

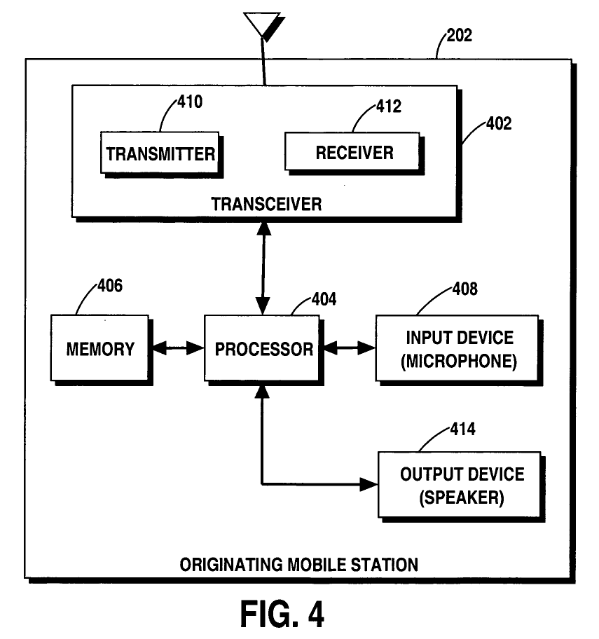

FIG. 4 is a block diagram of the origination mobile station 202 in accordance with the exemplary embodiment of the invention. A transceiver 402 including a transmitter 410 and receiver 412 exchanges wireless signals with a base station 108 to exchange information including voice, data, video, graphics, and audio. A processor 404 facilitates the execution of the various functions of the origination mobile station 202 as well as facilitating the overall functionality of mobile station 202. The processor 404 includes a microprocessor, computer, or other processor arrangement suitable for processing computer code to facilitate the execution of the functions described herein. The processor 404 may include other circuitry such as analog to digital (AD) converters and audio processors in some circumstances. The memory 406 is any memory module, integrated circuit (IC), or other device suitable for storing digital data such as the audio files representing the voicemail message and greeting message. An input device 408 connected to the processor 404 captures any combination of audio and video. In the exemplary embodiment, the input device 408 is a microphone and the voicemail message is an audio message. Examples of other suitable input devices 408 include video cameras and digital cameras. Greeting messages and other received communications are played through an output device 414 such as an audio speaker.

A voicemail server acknowledgment message is received through the receiver 412 indicating that an attempted call initiated by the destination mobile station 202 has been redirected to a voicemail server 104. The processor converts signals received by the input device 408 into a digital file representing the incoming signals to record the voicemail message. The file is at least temporarily stored in the memory 404 prior to inclusion in a MMS message generated by the processor 404. The message is transmitted by the transmitter 410 to the base station 108 to forward the MMS message to the MMS-C 116.

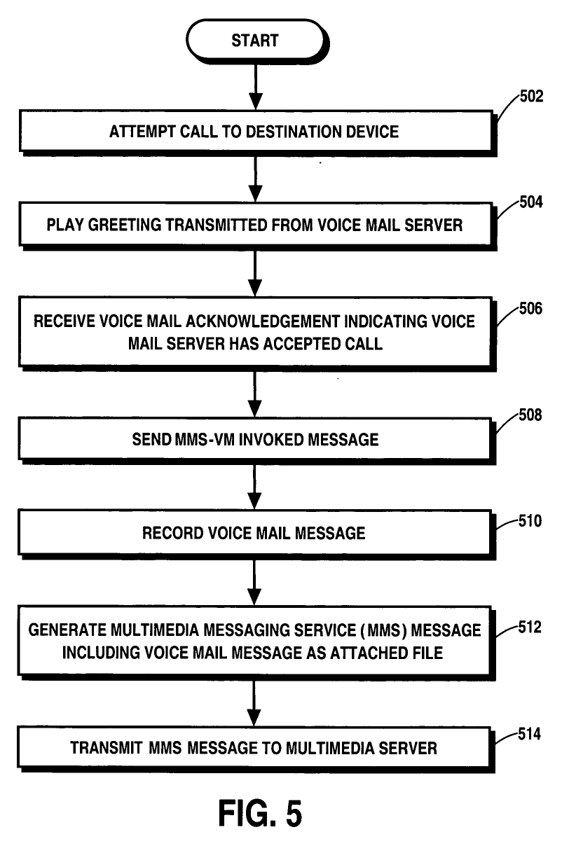

FIG. 5 is a flow chart of a method of providing voicemail service using a packet data messaging service such as MMS in accordance with the exemplary embodiment of the invention. The method is performed in an origination mobile device 202 in the exemplary embodiment and is described with reference to a MMS system. Those skilled in the art will readily apply the techniques discussed to other types of packet data messaging system based on these teachings.

At step 502, the origination mobile station 202 attempts to place a call to a destination device such as a destination mobile station 204. In the exemplary embodiment, the origination mobile station 202 attempts to complete a VoWP call with the destination device by establishing a session in accordance with SIP protocols.

At step 504, a greeting message is played to the origination party. In the exemplary embodiment, the greeting message is received as an audio file in a MMS message. In some circumstances a VoIP session or a circuit switched call is established between the origination mobile station 202 and the voicemail server 104 allowing the voicemail server 104 to play the greeting message through a virtual circuit switched connection or a circuit switched connection.

At step 506, a voicemail acknowledgment is received indicating that the call has been redirected to the voicemail server 104. In the exemplary embodiment, a message is sent using an SIP extension to notify the origination mobile station 202 that call has been redirected to the voicemail server 104. In a circuit switched network, the voicemail acknowledgment may transmitted through a circuit switched connection using either in-band or out of band signaling techniques.

At step 508, the origination mobile station 202 sends a MMS-invoked message to the voicemail server 104 indicating that the origination mobile station 202 is submitting the voicemail message using MMS. In the exemplary embodiment, the MMS-invoked message is sent using an SIP extension. In systems utilizing circuit switched networks, the MMS-invoked message is sent using in-band or out of band signaling. A circuit switched call is terminated after the message is sent. In come circumstances, the call may be terminated only after the greeting message is played. The steps shown in FG. 4 may be performed in any order. For example, the greeting message may be played after the MMS-invoked message is sent.

At step 510, a voicemail message is recorded. In the exemplary embodiment the voicemail message is an audio message recorded by a processor in the origination mobile station 202 by capturing the originating party's voice through a microphone 408. The voicemail message, however, may be any combination of audio, video, text, graphics or other multimedia information. Other devices such as cameras, for example, may be used to capture information for the voicemail message. The voicemail message is stored in memory 406 of the destination mobile station 202 as a digital file.

At step 512, a MMS message is generated by the origination mobile station 202. Using the destination address (IP routable address) of the destination mobile station 204, the origination mobile station 202 generates a MMS message and attaches the voicemail message file. In the exemplary embodiment, the IP address of the destination mobile station 204 used for the attempted VoIP call is used as the destination address. In circuit switched networks, the destination address is stored in a local database in the memory 406 or is received from the voicemail server 104. For example, the destination address may be entered by the originating party and associated with the telephone number of the destination device 204, 302. Where the voicemail server 104 provides the destination address, a message containing the destination address may be sent through the circuit-switched call or it may be forwarded to the destination mobile station 202 using MMS. Where the destination device 302 does not subscribe to the MMS, the destination address is a destination address associated with the voicemail box of the destination device 302. In some circumstances, the voicemail message file may be formatted in accordance with CODEC of the destination mobile station 204.

At step 514, the MMS message including the voicemail message file is sent to the destination device 204, 302. The MMS message is transmitted to the MMS-C 116 in accordance with known techniques.

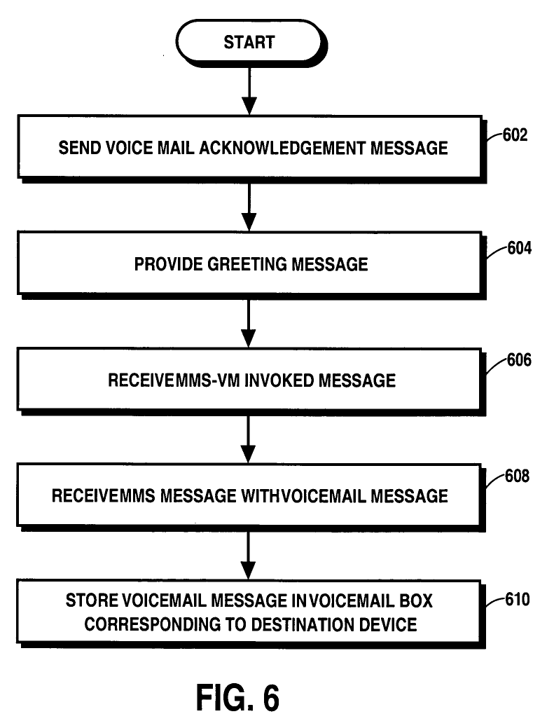

FIG. 6 is a flow chart of a method of providing voicemail service using a packet data messaging system such as MMS performed in a voicemail server 104. The method discussed with reference to FIG. 6 may be performed within a single device or by distributed equipment and is not limited to being performed only by the exemplary embodiments discussed herein. Those skilled in the art will readily apply the techniques discussed to other types of packet data messaging system based on these teachings.

At step 602, the voicemail server 104 sends a voicemail acknowledgment message to the origination mobile station 202. After the attempted call from the origination mobile station 202 is redirected to the voicemail server 104, the voicemail server 104 indicates that the call has been redirected. As explained above, the voicemail acknowledgement message is forwarded using an SIP extension in the exemplary embodiment.

At step 604, the voicemail server 104 provides a greeting message associated with the destination device 204, 302. In the exemplary embodiment, the greeting message is an audio file representing recorded speech that is forwarded to the origination mobile station 202 as a MMS message. The origination address of the origination mobile station 202 is used to create the appropriate header in the message and the greeting message is attached as an audio file to create the MMS message. In some circumstances, the greeting message may be played by the voicemail server 104.

At step 606, the voicemail server 104 receives the MMS-invoked message indicating that the origination mobile station 202 will submit the voicemail message using MMS. In the exemplary embodiment, the MMS-invoked message is received using an SIP extension. As discussed above, other techniques may be used to convey the MMS-invoked message.

At step 608, a voicemail message within a MMS message is received at the voicemail server 104. In the exemplary embodiment, step is performed where the destination device is a destination device 302 without MMS. The destination address provided by the voicemail server 104 to the origination mobile station 202 allows the MMS message to be routed to the appropriate location corresponding to the destination device 302. In some circumstances, the MMS message forwarded to the destination mobile station 204 may also be forwarded to the voicemail server 104.

At step 610, the voicemail message is forwarded from the MMS-C and stored in the voicemail server 104. The voicemail message is stored in a location corresponding to a voicemail box of the destination device 302.

Therefore, the exemplary embodiment efficiently provides voicemail service using MMS. Voicemail messages are deposited and retrieved using MMS minimizing the durations of real-time calls in the communication system 100. Voicemail messages deposited by a wireless user are recorded at an origination mobile station 202 and transmitted through a MMS communication link as a MMS message. Voicemail messages retrieved by a wireless user are received at a destination mobile station 204 through a MMS communication link and stored in memory at the destination mobile station 204. Voicemail clients that do not subscribe to MMS, or otherwise do not use the MMS, can retrieve voicemail messages using conventional techniques since the voicemail message are retained by the voicemail server 104. Employing a MMS system maximizes the efficiency of the use of wireless communication resources for voicemail services. Since a greater degree of latency can be tolerated with the transmission of a MMS message, a voicemail message can be efficiently transferred at a lower QoS (quality of service) level than required by circuit switched calls in circuit switched networks or virtual circuit switched calls in packet switched networks. In systems utilizing VoIP, efficiencies can be observed by utilizing a spectrally efficient 3G high speed radio link. Delivery can be scheduled to relieve burden of the communication networks 102, 110 during busy traffic periods. Further, delivery of the voicemail message using MMS minimizes inaccuracies and errors during delivery and maximizes voice quality since the possibility of frame errors or transcoding is eliminated. In conventional systems, for example, a voicemail message may be delivered by converting from wireless to PCM, from PCM to voice mail specific, from voicemail specific to PCM, and from PCM to wireless formats during submission. Also, features during message creation can be implemented without consuming airtime. In addition, voicemail messages may include multimedia components such as photographs, graphics, and video clips.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A method performed in an origination mobile station, the method comprising:
receiving a voicemail acknowledgment message indicating that an attempted call to a destination device has been redirected to a voicemail server;
recording a voicemail message at the origination mobile station; and
transmitting a packet data message including the voicemail message from the origination mobile station to a packet data messaging service center.

2. A method in accordance with claim 1, wherein the packet data message is a multimedia messaging service (MMS) message and the packet data messaging service center is a multimedia messaging service center (MMS-C).

3. A method in accordance with claim 1, further comprising:
terminating the call accepted by the voicemail server prior to recording the voicemail message.

4. A method in accordance with claim 3, further comprising:
presenting, to an originating party, a greeting transmitted by the voicemail server.

5. A method in accordance with claim 1, wherein voicemail message comprises an audio message and the recording comprises storing audio signals in a memory of the originating mobile station.

6. A method in accordance with claim 1, wherein the voicemail message comprises a video message and the recording comprises storing video signals in a memory of the originating mobile station.

7. A method in accordance with claim 1, further comprising:
generating the packet data message to include the voicemail message as an attached file.

8. A method in accordance with claim 7, wherein the destination device is a destination mobile station.

9. A method in accordance with claim 8, further comprising:
generating the packet data message to include a destination address of the destination mobile station.

10. A method in accordance with claim 9, wherein destination address is an electronic mail (email) address of the destination mobile station.

11. A method in accordance with claim 10, wherein the email address is an Internet Protocol (IP) format.

12. A method in accordance with claim 9, further comprising:
retrieving the destination address from memory, the destination address associated with a phone number of the destination mobile station.

13. A method in accordance with claim 9, further comprising:
receiving the destination address from the voicemail server.

14. A method in accordance with claim 9, further comprising:
receiving the destination address from the packet data messaging service center.

15. A method in accordance with claim 7, wherein the destination device is a landline telephone.

16. A method in accordance with claim 15, further comprising:
generating the packet data message to include a destination address of the landline telephone.

17. A method in accordance with claim 16, wherein destination address is an electronic mail (email) address associated with a voicemail box corresponding to the landline telephone.

18. A method in accordance with claim 17, wherein the email address is an Internet Protocol (IP) format.

19. A method in accordance with claim 16, further comprising:
receiving the destination address from the voicemail server.

20. A method in accordance with claim 16, further comprising:
receiving the destination address from the packet data messaging service center.

21. A method comprising:
transmitting a voicemail acknowledgement message to an origination mobile station indicating an attempted call initiated by the origination mobile station has been redirected to a voice mail server.

22. A method in accordance with claim 21, wherein the voicemail acknowledgment message is transmitted over a voice over Internet protocol (VoIP) communication link using a session initiation protocol (SIP) extension.

23. A method in accordance with claim 21, wherein the voicemail acknowledgment message is transmitted over a circuit switched communication link.

24. A method in accordance with claim 21, further comprising:
receiving a multimedia messaging service invoked (MMS-invoked) message from the origination mobile station indicating that the origination mobile station will submit a voicemail message using multimedia messaging service (MMS).

25. A method in accordance with claim 24, further comprising:
terminating a session with the origination mobile station in response to the MMS-invoked message.

26. A method in accordance with claim 21 further comprising:
receiving a multimedia messaging service (MMS) message comprising a voicemail message recorded at an originating mobile station in response to the voicemail acknowledgment received at the originating mobile station.

27. A method in accordance with claim 21, wherein the destination device is a landline telephone, the method further comprising:
providing an alert message indicating a voicemail message has been received for the landline telephone.

28. A method in accordance with claim 27, wherein the MMS message comprises a destination address corresponding to a voicemail box of the destination device.

29. A method in accordance with claim 27, wherein the email address is an internet protocol (IP) format.

30. A method in accordance with claim 26, further comprising:
transmitting audio information to play the voicemail message through the land line telephone.

31. A mobile station comprising:
a receiver configured to receive a voicemail acknowledgment message indicating that a voicemail server has accepted a call to a destination device;
a processor configured to convert an input signal received through an input device into a digital file to record a voicemail message and generate a packet data message comprising the voicemail message; and
a transmitter configured to transmit the packet data message including the voicemail message from the origination mobile station to a packet data messaging service center.

32. A mobile station in accordance with claim 31, wherein the packet data message is a multimedia messaging service (MMS) message and the packet data messaging service center is a multimedia messaging service center (MMS-C).

33. A mobile station in accordance with claim 31, wherein processor is further configured to terminate the call accepted by the voicemail server prior to recording the voicemail message.

34. A mobile station in accordance with claim 31, further comprising an output device configured to present a greeting transmitted by the voicemail server.

35. A mobile station in accordance with claim 31, wherein the voicemail message comprises audio signals, mobile station further comprising a memory for storing the audio signals.

36. A mobile station in accordance with claim 31, wherein the voicemail message comprises video signals, mobile station further comprising a memory for storing the video signals.

37. A mobile station in accordance with claim 31, wherein the packet data message comprises an address of the destination device.

38. A mobile station in accordance with claim 37, wherein the destination address is an electronic mail (email) address of the destination mobile station.

39. A mobile station in accordance with claim 38, wherein the email address in an Internet Protocol (IP) format.

40. A voicemail server configured to transmit a voicemail acknowledgement message to an origination mobile station indicating an attempted call initiated by the origination mobile station has been redirected to a voice mail server.

41. A voicemail server in accordance with claim 40, the voice mail server further configured to transmit the voicemail acknowledgment message over a voice over Internet Protocol (VoIP) communication link using a session initiation protocol (SIP) extension.

42. A voicemail server in accordance with claim 40, the voice mail server further configured to transmit the voicemail acknowledgment message over a circuit switched communication link.

43. A voicemail server in accordance with claim 40, the voice mail server further configured to receive a multimedia messaging service invoked (MMS-invoked) message from the origination mobile station indicating that the origination mobile station will submit a voicemail message using multimedia messaging service (MMS).

44. A voicemail server in accordance with claim 40, the voice mail server further configured to terminate the call with the origination mobile station in response to the MMS-invoked message.

45. A voicemail server in accordance with claim 40, the voice mail server further configured to receive a multimedia messaging service (MMS) message comprising a voicemail message recorded at an originating mobile station in response to the voicemail acknowledgment received at the originating mobile station.
